(19) United States
(12) Patent Application Publication
(10) Pub. No.: US 2012/0008312 A1
(43) Pub. Date: Jan. 12, 2012

(54) PORTABLE CARD EMERGENCY ILLUMINATING SYSTEM

(75) Inventor: Je-Hsiang LEE, Taoyuan County (TW)

(73) Assignee: ENERLIGHTING CORP., Taoyuan County (TW)

(21) Appl. No.: 12/877,599

(22) Filed: Sep. 8, 2010

(30) Foreign Application Priority Data
Jul. 6, 2010 (TW) 099122252

(51) Int. Cl. F21L 4/08; F21L 4/00

(52) U.S. Cl. 362/183; 362/157

(57) ABSTRACT

A portable illuminating system is provided. The portable illuminating system includes an illuminating card providing a light; a cartridge socket retaining the illuminating card; and a battery base electrically connected with the cartridge socket and retaining a battery providing an electric power to the illuminating card.

### FIELD OF THE INVENTION

The present invention relates to a portable card emergency illuminating system. More particularly, the present invention relates to an emergency illuminating system having a light source disposed on a thin card.

### BACKGROUND OF THE INVENTION

Conventional emergency illuminations are used to be designed as a fixture and mounted at a higher place of wall. A user can light up a dark space by the emergency illuminations when power failure. Usually, if a user has demands to light up, for instances, an inner space in a wardrobe, a ceiling or a corner under table, he/she has to move the emergency illumination from the higher place first. Therefore, the user needs to block himself up to a specific height to reach the emergency illumination and to demount it from the wall. Then the illumination can be applied to the demanded field as a provisional illumination. Thus, it is apparent that an applicability of the conventional emergency illuminations is not flexible enough.

Please refer to FIG. 1, which is a diagram illustrating a conventional emergency illumination which is configured as a ballast LED. The conventional emergency illumination 10 in FIG. 1 consists of a plurality of ballast LED 11 and is disposed on a panel 12. There is a plurality of holes 14 opened on the panel 12 for containing the plurality of ballast LED 11. However, the illumination 10 usually has a huge volume which is not suitable for portable and being a provisional illumination. Furthermore, the ballast LED 11 and the holes 14 configured on the panel 12 of such illumination 10 provide a bumpy appearance which is not artistic.

Therefore, it becomes issues regarding how to overcome the defects which a conventional emergency illumination is not suitable for being a provisional illumination and has bumpy looking thereof. In order to overcome the drawbacks in the prior art, after experiments, tests and researches, the inventor obtains a portable card emergency illumination system. The system not only can efficiently resolve the defects which a conventional emergency illumination is not suitable for being a provisional illumination and has bumpy looking thereof, but also has portable characteristic. The particular system in the present invention not only solves the problems described above, but also is easy to be implemented. Thus, the invention has the utility for the industry.

### SUMMARY OF THE INVENTION

The concept of the present invention provides an illuminating system which mainly utilizes a flip chip LED with low power consumption as the lighting source and the flip chip LED is embedded onto a thin card. The illuminating system has characteristics of low power consumption, portability, ultra slim and thin body and having light emitting angle of 180° degrees. The invention is different from the conventional lighting fixture and the individual module can be adaptively configured and merged into the application environment according to the practical demands for the illumination.

In accordance with the first aspect of the present invention, a portable illuminating system is provided. The portable illuminating system includes an illuminating card providing a light; a cartridge socket retaining the illuminating card; and a battery base electrically connected with the cartridge socket and retaining a battery providing an electric power to the illuminating card.

Preferably, the illuminating card has a light module comprising a flip chip LED.

Preferably, the flip chip LED provides a planar light source having an emitting angle of 180° degrees.

Preferably, the planar light source has a flat illuminating surface.

Preferably, the cartridge socket is a dual panel assembly comprising a first panel with an opening thereon and a second panel, there is a slot between the first panel and the second panel, which allow the illuminating card to insert into the slot.

Preferably, the illuminating card is immovably retained in and relative to the dual panel assembly, and the light module is exposed from the first panel via the opening.

Preferably, the battery base and the cartridge socket are connected with each other through a connecting set having a male connector and a female connector, one of which is disposed on the battery base and the other of which is disposed on the cartridge socket.

Preferably, the second side has a first end on which one of the male connector and the female connector is disposed.

Preferably, the illuminating card has a positive electrode and a negative electrode, and the cartridge socket has a contacting portion electrically connected with the positive electrode and the negative electrode.

Preferably, the battery is one of an AA3 battery and a button battery.

In accordance with the second aspect of the present invention, an illuminating system is provided. The illuminating system includes a card; a lighting source disposed on the card; and a power socket retaining the card and providing a power to the lighting source.

Preferably, the power socket further comprises a cartridge socket retaining the card and a battery base retaining a battery and electrically connecting the cartridge socket.

Preferably, the battery is one of a rechargeable battery and a photovoltaic cell and provides an electric power to the lighting source.

In accordance with the third aspect of the present invention, an illuminating system is provided. The illuminating device includes a card; a lighting source disposed on the card; and a power supply disposed on the card for providing an electric power to the lighting source.

In accordance with the fourth aspect of the present invention, an illuminating system is provided. The illuminating device includes a card; and a lighting source disposed on the card and providing an illumination while accepting an energy.

Other objects, advantages and efficacy of the present invention will be described in detail below taken from the preferred embodiments with reference to the accompanying drawings, in which:

### BRIEF DESCRIPTION OF THE DRAWINGS

FIG. 1 is a diagram illustrating a conventional emergency illumination with a plurality of ballast LEDs;

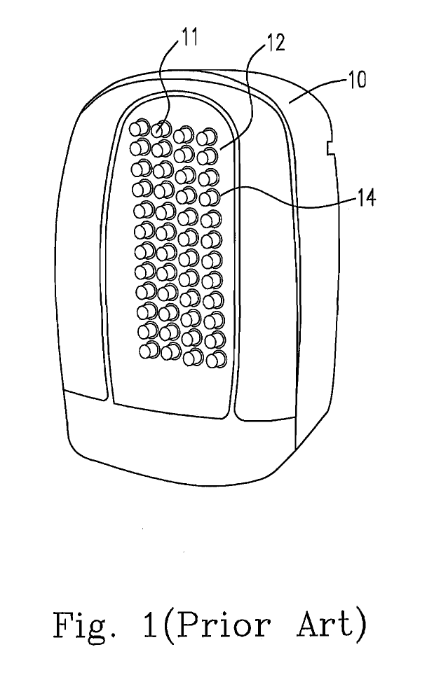

FIG. 2 is a decomposition diagram illustrating a portable illuminating system according to the present invention;

FIG. 3 is a composition diagram illustrating a portable illuminating system according to the present invention; and

FIG. 4 is a diagram illustrating the battery base utilized in the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purposes of illustration and description only; it is not intended to be exhaustive or to be limited to the precise form disclosed.

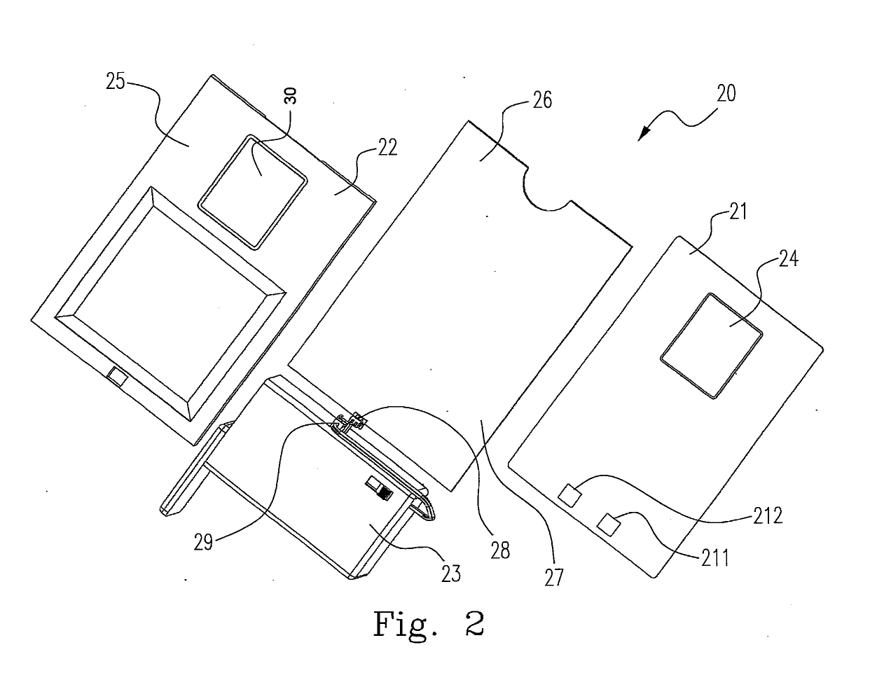

Please refer to FIG. 2, which is a decomposition diagram illustrating a portable illuminating system according to the present invention. The present invention relates to a portable illuminating system 20 which includes an illuminating card 21 having a positive electrode 211 and a negative electrode 212 and for providing a light, a cartridge socket 22 for retaining the illuminating card 21 and a battery base 23 electrically connected with the cartridge socket 22. There is a light module disposed on the illuminating card 21 and the light module includes a flip chip LED 24.

The cartridge socket 22 is a dual panel assembly consisting of a first panel 25 with an opening 30 and a second panel 26. The second panel 26 has a first end 27 where a male connector 28 of a connecting set, for instance, a 2P electrical terminal for inputting an electric power. The male connector 28 is utilized for connecting with another connector, a female connector 29, of the connecting set disposed on the battery base 23. The female connector 29 is disposed on a connection of the battery base 23 for electrically connecting with a battery retained in the battery base 23. The connecting set can direct the electric power sourced from a photovoltaic cell or other electricity generating device to input to the battery if a rechargeable battery is used. The cartridge socket 22 can be arbitrarily put on a wall or portable.

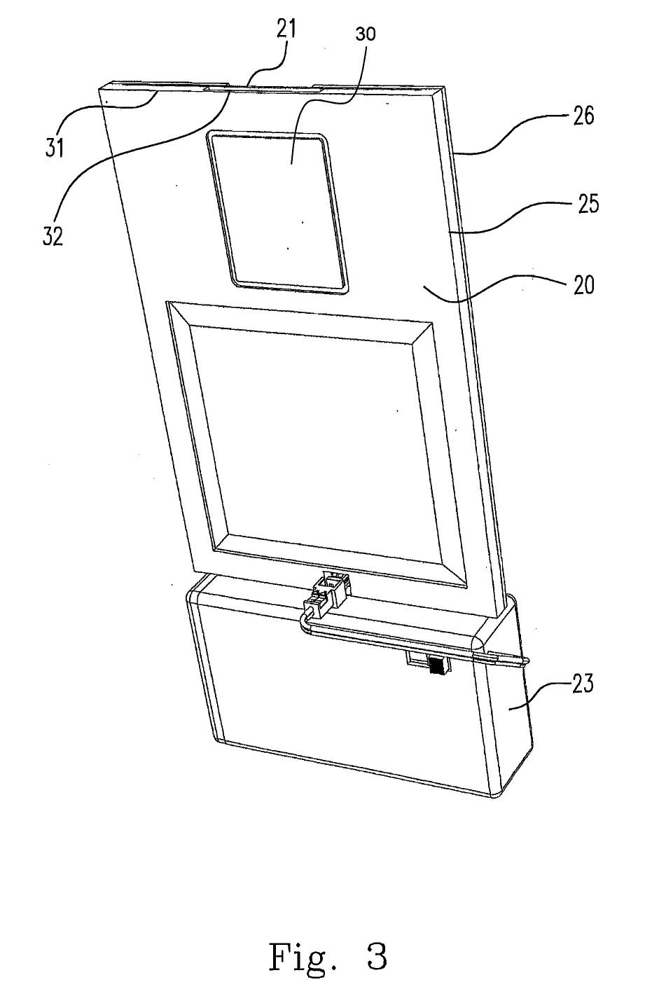

Please refer to FIG. 3, which is a composition diagram illustrating a portable illuminating system according to the present invention. It is shown that the illuminating card 21 is retained in a space formed between the first panel 25 and the second panel 26 and there is a slot 32 formed at a first end 31 of the first panel 25 of the dual panel assembly for providing the illuminating card 21 to slide into the space. The illuminating card 21 is to be inserted into the space through the slot 32 and the flip chip LED 24 is exposed from the first panel 25 via the opening 30.

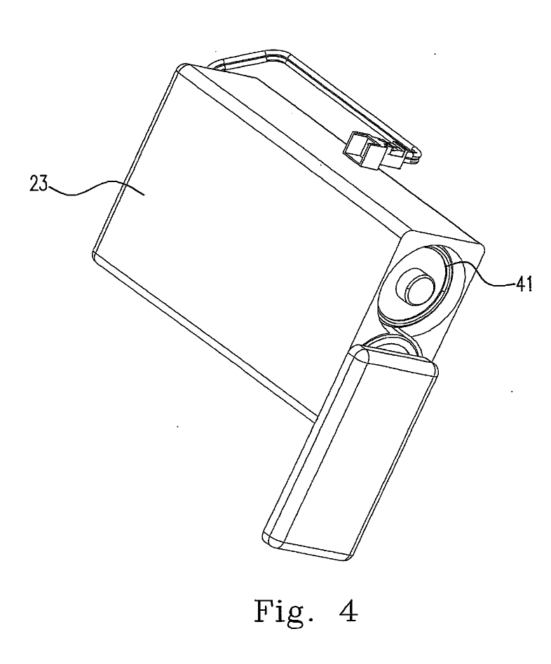

Please refer to FIG. 4, which is a diagram illustrating the battery base utilized in the present invention. It is shown in FIG. 4 that the battery base 23 is a common battery holder that is easily available from the current market. The battery holder can retain two AA3 batteries 41 for forming a battery set and providing an electric power to the flip chip LED 24 disposed on the illuminating card 21. The battery base can be refitted as a battery holder for retaining a button battery or other equivalents.

The flip chip LED 24 which is a solid state illuminating element can provide a planar light source having a light emitting angle of 180° degrees and a flat illuminating surface. There is a contacting portion (not shown in FIG. 4), disposed on the cartridge socket 22, which is utilized for electrically connecting with the positive electrode 211 and the negative electrode 212 of the illuminating card 21. The illuminating card 21 in the present invention is preferably an EM card, an easy card, a credit card, a visa card, a health insurance card or an I-Cash pre-paid card etc. and has a length around 8.52 cm, a width around 5.4 cm and a height (thickness) around 0.6-0.2 cm.

Accordingly, a second embodiment derived from the first embodiment is provided. The present invention relates to an illuminating system 20 includes a card 21, a light 24 that is preferably a flip chip LED disposed on the card 21, a power socket, which includes the cartridge socket 22 and the battery base 23, is utilized for providing an electric power to the light 24 and retaining the card 21.

Accordingly, a third embodiment derived from the first embodiment is provided. The present invention relates to an illuminating system 20 includes a card 21, a light 24 that is preferably a flip chip LED disposed on the card 21, a power source for providing an electric power to the light and a connecting element 22 that is preferably a cartridge socket for retaining the card and electrically connecting the power source with the card 21. The illuminating system 20 further includes a battery base 23 that is electrically connected to the cartridge socket 22 for retaining the battery. The battery is preferably a rechargeable battery, a photovoltaic cell with 3 (volt) voltages or other electric generating device. The connecting element can also be other common-seen simple cartridge socket which has only one panel. There is a plurality of clips disposed at the boundary of the panel for retaining the card 21. Therefore, the second panel is omitted.

Accordingly, a fourth embodiment derived from the first embodiment is provided. The present invention relates to an illuminating system 20 includes a card 21, a light 24 disposed on the card 21 and a power supply. It is noted that the power supply is directly configured on the card 21 for supplying and providing an electric power to the light 24 and the power supply is preferably a photovoltaic cell.

The present invention relates to a portable and mobile emergency illumination which can be a simple interior illumination, an exterior illumination, an outdoor individual illumination and an indication illumination. The illuminating system 20 in the present invention can be applied to the outdoor activities (e.g. the mountain climbing, the camping or the hiking), the emergency illumination, the emergency rescue, the direction indication or the standby illumination etc., especially for the regions having difficulties on electric power supply. The illuminating system 20 can be also disposed on a stationary site as a night illumination.

While the invention has been described in terms of what is presently considered to be the most practical and preferred embodiments, it is to be understood that the invention needs not be limited to the disclosed embodiments. Therefore, it is intended to cover various modifications and similar configuration included within the spirit and scope of the appended claims, which are to be accorded with the broadest interpretation so as to encompass all such modifications and similar structures.

What is claimed is:

1. A portable illuminating system, comprising:
an illuminating card providing a light;
a cartridge socket retaining the illuminating card; and
a battery base electrically connected with the cartridge socket and retaining a battery providing an electric power to the illuminating card.

2. The portable illuminating system according to claim 1, wherein the illuminating card has a light module comprising a flip chip LED.

3. The portable illuminating system according to claim 2, wherein the flip chip LED provides a planar light source having an emitting angle of 180° degrees.

4. The portable illuminating system according to claim 3, wherein the planar light source has a flat illuminating surface.

5. The portable illuminating system according to claim 1, wherein the cartridge socket is a dual panel assembly comprising a first panel with an opening thereon and a second panel, there is a slot between the first panel and the second panel, which allow the illuminating card to insert into the slot.

6. The portable illuminating system according to claim 5, wherein the illuminating card is immovably retained in and relative to the dual panel assembly and the light module is exposed from the first panel via the opening.

7. The portable illuminating system according to claim 5, wherein the battery base and the cartridge socket are connected with each other through a connecting set having a male connector and a female connector, one of which is disposed on the battery base and the other of which is disposed on the cartridge socket.

8. The portable illuminating system according to claim 7, wherein the second side has a first end on which one of the male connector and the female connector is disposed.

9. The portable illuminating system according to claim 1, wherein the illuminating card has a positive electrode and a negative electrode, and the cartridge socket has a contacting portion electrically connected with the positive electrode and the negative electrode.

10. The portable illuminating system according to claim 1, wherein the battery is one of an AA3 battery and a button battery.

11. An illuminating system, comprising:
a card;
a lighting source disposed on the card; and
a power socket retaining the card and providing a power to the lighting source.

12. The illuminating system according to claim 11, wherein the power socket further comprises a cartridge socket retaining the card and a battery base retaining a battery and electrically connecting the cartridge socket.

13. The illuminating system according to claim 12, wherein the battery is one of a rechargeable battery and a photovoltaic cell and provides an electric power to the lighting source.

14. An illuminating device, comprising:
a card;
a lighting source disposed on the card; and
a power supply disposed on the card for providing an electric power to the lighting source.

15. An illuminating device, comprising:
a card; and
a lighting source disposed on the card and providing an illumination while accepting an energy.
